(19) United States
(12) Patent Application Publication
(10) Pub. No.: US 2009/0027216 A1
(43) Pub. Date: Jan. 29, 2009

(54) OXYGEN SENSING DEVICE

(76) Inventors: Chung-Chin HUANG, Taichung (TW); Chin-Ying Huang, Taichung (TW); Hsin-Ming Huang, Taichung (TW); Hsing-Hsiung Huang, Taichung (TW); Chung-Sheng Yen, Taichung (TW); Kuan-Chou Lin, Taichung (TW)

Correspondence Address: LEONG C LEI, PMB # 1008, 1867 YGNACIO VALLEY ROAD, WALNUT CREEK, CA, 94598, US

(21) Appl. No.: 11/829,093

(22) Filed: Jul. 27, 2007

(51) Int. Cl. G08B 17/117

(52) U.S. Cl. 340/632

(57) ABSTRACT

The oxygen sensing device contains a power circuit supplying the electricity required, an oxygen sensor for detecting the oxygen concentration in the atmosphere, an alarm system issuing an audible or visual alarm signal, and a controller. The controller is a computing device having a preset threshold value that continuously obtains the current oxygen concentration from the oxygen sensor. The controller then can calculate and obtain the variation rate of the oxygen concentration in a unit time. If the controller detects that the current oxygen concentration is about to drop below the threshold value, it will activate the alarm system to issue an alarm to alert people to take immediate and proper action.

### TECHNICAL FIELD OF THE INVENTION

The present invention generally relates to oxygen sensing devices, and more particularly to a device monitoring indoor oxygen concentration and issuing an alarm when the oxygen concentration is about to drop below a threshold value.

### DESCRIPTION OF THE PRIOR ART

Normal atmosphere contains around 20.95 percent oxygen. An oxygen deficient atmosphere is defined as any atmosphere that contains less than 18 percent oxygen. Oxygen-deficient atmospheres may be created when oxygen is displaced by inserting gases, such as carbon dioxide, nitrogen, or argon. Oxygen can also be consumed by rusting metal, ripening fruits, drying paint, or coatings, combustion, or bacterial activities.

Oxygen-deficient atmospheres are the leading cause of confined space fatalities. Studies have shown that, when the oxygen concentration is below 18 percent, it would be too late to evacuate people working in the confined space as their ability to escape would already be impaired. Therefore, it has been suggested that the oxygen concentration in a confined space should be maintained to be at least 20.5 percent. Once the concentration is below 20.5 percent evacuation has to be conducted immediately.

### SUMMARY OF THE INVENTION

The primary purpose of the present invention is to provide an oxygen sensing device. The oxygen sensing device contains a power circuit supplying the electricity required, an oxygen sensor for detecting the oxygen concentration in the atmosphere, an alarm system issuing an audible or visual alarm signal when activated, and a controller.

The controller is a computing device having a preset threshold value that continuously obtains the current oxygen concentration from the oxygen sensor. The controller then can calculate and obtain the variation rate of the oxygen concentration in a unit time. If the controller detects that the current oxygen concentration is about to drop below the threshold value, it will activate the alarm system to issue an alarm to alert people to take immediate and proper action.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing the various functional blocks of an oxygen sensing device according to an embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

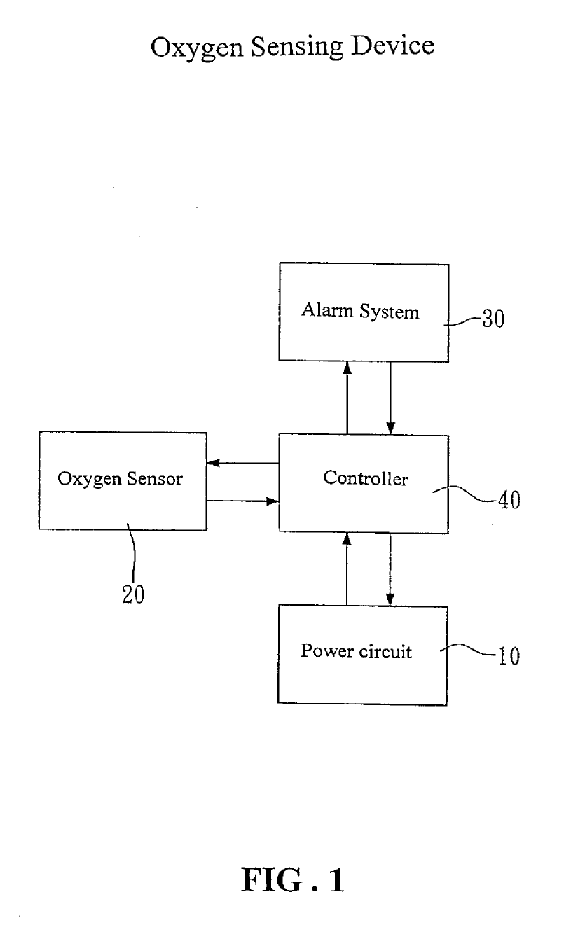

As illustrated in FIG. 1, an oxygen sensing device according to an embodiment of the present invention contains a power circuit 10 supplying the electricity required by the oxygen sensing device, an oxygen sensor 20 for detecting the oxygen concentration in the atmosphere, an alarm system 30 containing a circuit for issuing audible alarm signal (e.g., buzzing sound) or a visual alarm signal (e.g., flashing light), and a controller 40.

The controller 40 is electrically connected to the power circuit 10, the oxygen sensor 20, and the alarm system 30. The controller 40 is a computing device having a preset threshold value such as 20.5 percent. The controller 40 continuously obtains the current oxygen concentration from the oxygen sensor 20. The controller 40 then can calculate and obtain the variation rate of the oxygen concentration in a unit time (e.g., a minute). Based on the variation rate and the threshold value, if the controller 40 detects that the current oxygen concentration is about to drop below the threshold value, it will activate the alarm system 30 to issue an audible or visual alarm to alert people to take immediate and proper action. When the current oxygen concentration actually drops below the threshold value, the controller 40 can activate the alarm system 30 to issue a more serious alarm. In other words, the controller 40 can issue different types of alarm based on how fast the oxygen concentration drops and whether the current oxygen concentration actually drops below the threshold value.

The power circuit 10, the oxygen sensor 20, the alarm system 30, and the controller 40 can be integrally assembled in a single device installed inside a confined space. In some alternative embodiments, it is the oxygen sensor 20 and the alarm system 30 that are inside the confined space, and the power circuit 10 and the controller 40 are outside the confined space, with appropriate electrical connections therebetween.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An oxygen sensing device, comprising:
a power circuit supplying the electricity required by said the oxygen sensing device;
an oxygen sensor installed inside a confined space for detecting an oxygen concentration in the atmosphere inside said confined space;
an alarm system capable of issuing an audible or visual alarm signal when activated; and
a controller electrically connected to said power circuit, said oxygen sensor, and said alarm system, said controller continuously obtaining said oxygen concentration from said oxygen sensor;
wherein said controller has a preset threshold value; and said controller activates said alarm system when said controller detects that said oxygen concentration is about to drop below said threshold value.

2. The oxygen sensing device according to claim 1, wherein said controller calculates a variation rate of said oxygen concentration in a unit time so as to determine whether said oxygen concentration is about to drop below said threshold value.

3. The oxygen sensing device according to claim 1, wherein said threshold value is 20.5 percent.
